(19) United States
(12) Patent Application Publication
(10) Pub. No.: US 2011/0267382 A1
(43) Pub. Date: Nov. 3, 2011

(54) DUAL SOURCE BACKLIGHT UNIT FOR USE WITH A DISPLAY, A DISPLAY SYSTEM AND METHOD

(75) Inventors: Jeffrey FERGASON, Menlo Park, CA (US); John FERGASON, Sunnyvale, CA (US); Arthur BERMAN, San Jose, CA (US)

(73) Assignee: FERGASON PATENT PROPERTIES, LLC, Menlo Park, CA (US)

(21) Appl. No.: 13/098,825

(22) Filed: May 2, 2011

Related U.S. Application Data
(60) Provisional application No. 61/330,558, filed on May 3, 2010.

(51) Int. Cl. G09G 5/10; G02F 1/13357

(52) U.S. Cl. 345/690; 362/97.1; 362/97.2; 345/102

(57) ABSTRACT

A display system, method and backlight unit for use with a display. The backlight unit includes a first light source and a second light source, wherein the first light source and the second light source are controllable independently of each other. The sum of light produced by the light sources illuminates the display to achieve illumination brightness capability of a higher intensity capable single light source. Changes in spectral characteristics and/or brightness characteristics due to aging or the like may be compensated. The first light source may provide a base line illumination level for the display and the second light source may be modulated to dynamically increase contrast and/or contrast ratio characteristics of the image being shown on the display to a viewer.

### TECHNICAL FIELD

Aspects of the present invention relate generally to a system and method for utilizing a backlight unit (BLU) having two independently controllable light sources to illuminate a display and to a display device for showing images using such BLU.

### BACKGROUND

Conventional optical displays typically display graphic visual information, such as computer generated graphics, and pictures generated from video signals, such as from a video recorder, from a broadcast television signal, etc.; the pictures may be static or still or they may be moving pictures, as in a movie or in a cartoon, for example. Conventional displays also may present visual information of the alphanumeric type, such as numbers, letters, words, and/or other symbols (whether in the English language or in another language).

A liquid crystal display (sometimes referred to below as LCD) is an example of a passive display. For example, in a passive display light from a light source (sometimes referred to as backlight unit or as BLU) is provided, e.g., is incident on, a light modulating device, e.g., the liquid crystal component, which may modulate the light to increase or to decrease (e.g., to determine or to control) the amount (e.g., sometimes synonymously referred to as brightness or intensity) of light that is transmitted or blocked or that is reflected or is not reflected by the liquid crystal component, thereby to create an image. The liquid crystal component may be, for example, a liquid crystal cell (sometimes referred to as a liquid crystal panel) and one or more optical polarizer devices. Sometimes the liquid crystal cell or panel is assembled as a unit including one or more optical polarizers. The term LCD may be used herein collectively to refer not only to liquid crystal displays but also to other passive displays, e.g., electrochromic displays, digital micromirror devices (DMD), and so on.

A conventional LCD has a backlight unit (BLU) that contains a single light source that may be composed of one or more lighting elements. A control may adjust brightness of the light source of a BLU, e.g., to increase brightness in a bright environment to make the image more easily seen or to darken the image when in a dark environment so the image is not straining on the eyes of the viewer or contrasting with the ambient light level in the local environment where the image is viewed. There may be other reasons to adjust the brightness of the image shown on the display, e.g., according to preferences of a user. The light source of a BLU may be selected according to the maximum brightness capability of the image shown on the display, e.g., for bright image capability the light source must have sufficiently high brightness output capability; and the maximum brightness capability of the light source is a limiting factor in maximum brightness capability of the display. This presents several problems because bright output light sources usually are more expensive than relatively lower light level output light sources, e.g., comparing a light source capable of producing maximum light output that is relatively bright to a light source capable of producing maximum light output that is relatively less bright. Also, bright output light sources usually require more energy for operation, are less energy efficient, and may produce more heat than relatively lower light level output light sources. The mentioned heat may be a detriment to the display, may not contribute to brightness of light output from the light source and also may further reduce energy efficiency because of the need for energy to cool the display.

The light output produced by a BLU can be modulated by a technique called by various names, e.g., System Synchronized Brightness Control (referred to below as SSBC), dynamic contrast control, and possibly other names. For brevity, such systems and techniques will be referred to collectively as SSBC below. BLUs used in the past in such display systems that have employed such techniques have been relatively expensive and energy inefficient because of the relatively high intensity (also referred to as brightness) light requirements and corresponding relatively high energy requirements.

In an exemplary LCD there usually are a plurality of picture elements, sometimes referred to as pixels or pels, and these pixels can be selectively operated to modulate light from a light source to produce a visual output in the form of a picture, alphanumeric information, etc. Various techniques may be used to provide signals to the pixels to cause a particular type of optical output from respective pixels, e.g., extent of light modulation, such as light transmission and/or light redirection or light blocking affect.

One factor in determining resolution of a LCD is the number of picture elements per unit area of the liquid crystal display. The picture elements (pixels or pels) may be discrete pixels, blocks or areas that are operated to develop or to provide an image by the LCD transmitting or blocking light transmission or reflecting or not reflecting light. The optical output provided by one or more pixels may be white (or black), one or more colors or light of a particular color, and such optical output may be characterized as having a given shade of gray, gray shade, gray level or gray scale (these terms being used substantially synonymously).

Techniques are known to obtain different amounts of light transmission by a LCD and thereby to obtain gray scale. Gradation of the light output from a LCD for a given intensity of brightness of light that is incident on the LCD may be controlled.

In a color display, such as a LCD, color images may be obtained using a triad of colors, e.g., red, green and blue pixels, or cyan, magenta and yellow pixels, or possibly other color combinations of pixels that form a color triad (hereinafter referred to as triad).

The displaying of a dark scene or a bright scene using a passive display device encounters a disadvantage that ordinarily is not present for displays which produce their own light, such as a cathode ray tube (CRT). The problem has to do with reduced resolution, contrast, contrast ratio and/or gray scale characteristic of the displayed image.

One practice to reduce brightness of a displayed image or scene shown on a passive display had been to reduce the number of pixels which are transmitting light at a particular moment. Another approach had been to vary pixel transmission to a limited extent. Such approaches have tended to reduce resolution, contrast, range of gray levels and/or number of gray levels of the displayed image. The human eye has difficulty distinguishing between seeing or recognizing the difference between features or contrasting parts of an image that has a low contrast range and is of either of a low brightness or a high brightness. This difficulty is increased when the number of pixels is decreased and/or when the number and/or range of gray levels is relatively low.

The mentioned SSBC techniques increase the range and/or number of gray levels of the image and correspondingly adjust the intensity of light that is incident on the display for dim or bright images, respectively. These adjustments may be made to the gray levels and incident light with an effort to portray a good quality image with brightness or darkness characteristics as originally intended for the image, e.g., images under natural illumination conditions, such as relatively bright environments on a bright sunlit beach or in relatively dim environments in a moonlit or candlelit area, and so on.

### SUMMARY

There are a variety of problems with a LCD having a single light source. To obtain bright images lighting elements that emit electromagnetic radiation at a high light level have been used, but these are more expensive than those that emit electromagnetic radiation at a lower light level. Also, lighting elements that produce a high light level generally are less efficient than those elements that emit radiation at a lower light level. As lighting elements age, the spectral characteristics may change and detrimentally affect the spectral characteristics of images produced by the LCD.

An aspect of the present invention relates to a lighting unit for a passive display, including a first light configured to illuminate a passive display, a second light configured to illuminate the passive display, and wherein the first light and second light are independently controllable.

Another aspect relates to the prior aspect and wherein the sum of the total light capability of the first light and second light is at least approximately the maximum light intended for illuminating the display.

Another aspect relates to one or more of the prior aspect(s) and wherein at least one light provides minimum light for operating the display to show a directly viewable or projectable image absent any light from the other light.

Another aspect relates to one or more of the prior aspect(s) and wherein the lights are cooperatively operable to provide illumination of a display over the full intended operating brightness of the display.

Another aspect relates to one or more of the prior aspect(s) and herein at least one of the lights includes a plurality of lighting elements.

Another aspect relates to one or more of the prior aspect(s) and wherein each of the lights includes a plurality of lighting elements.

Another aspect relates to one or more of the prior aspect(s) and wherein at least one of the lights includes LEDs.

Another aspect relates to one or more of the prior aspect(s) and wherein at least one of the lights includes at least one fluorescent tube.

Another aspect relates to one or more of the prior aspect(s) and wherein at least one of the lights includes a laser.

Another aspect relates to one or more of the prior aspect(s) and wherein at least one of the lights is configured to control the spectral output of light provided thereby.

Another aspect relates to a passive display including a light modulator configured to modulate light to show an image, and the lighting unit according to one or more of the prior aspects configured to illuminate the light modulator.

Another aspect relates to one or more of the prior aspect(s) and wherein at least one of the lights provides a color output and is configured to create natural illumination or enhanced color of the image to adjust for changes due to aging or the like.

Another aspect relates to one or more of the prior aspect(s) and further including a detector configured to measure spectral output of at least one of the lights.

Another aspect relates to one or more of the prior aspect(s) and further including a control configured to control operation of at least one of the lights over a range of brightness levels.

Another aspect relates to one or more of the prior aspect(s) and wherein the control is configured to increase the range or number of gray levels shown by the light modulator for dim images or bright images and to coordinate controlling of at least one of the lights therewith.

Another aspect relates to one or more of the prior aspect(s) and wherein the sum of maximum brightness light of the first light and second light is at least substantially the same as the maximum brightness light of a single relatively higher powered light.

Another aspect relates to one or more of the prior aspect(s) and wherein the light modulator is a liquid crystal device.

Another aspect relates to one or more of the prior aspect(s) and wherein the light modulator includes a plurality of mirrors.

Another aspect relates to one or more of the prior aspect(s) and wherein the light modulator is a digital micromirror device.

Another aspect relates to a display device for displaying an image, the display device including a passive display panel; a backlight unit configured to illuminate the display panel; and at least one control operatively coupled to the passive display panel and the backlight unit; wherein the backlight unit includes a first independently controllable light source and a second independently controllable light source, wherein the first light source is controlled to provide substantially constant light output and the second light source is controlled to provide modulated light output.

Another aspect relates to a display device according to one or more prior aspects wherein the passive display panel includes a LCD.

Another aspect relates to a display device according to one or more prior aspects wherein the passive display panel includes a multiple mirrors.

Another aspect relates to a display device according to one or more prior aspects wherein the passive display panel includes a digital micromirror device.

Another aspect relates to a display device according to one or more prior aspects wherein the passive display panel includes a ferroelectric display.

Another aspect relates to a display device according to one or more prior aspects wherein the control controls operation of both light sources.

An aspect of the invention relates to a display device for displaying an image, the display device including a passive display panel; a backlight unit configured to illuminate the display panel; and at least one control operatively coupled to the passive display panel and the backlight unit; wherein the backlight unit includes a first independently controllable light source and a second independently controllable light source, wherein the first light source is controlled to provide substantially constant light output and the second light source is controlled to provide modulated light output.

An aspect of the invention relates to a display system including a display for producing an output image representative of an image signal; a backlight unit configured to illuminate the display and including a first light source and a second light source, wherein the first light source and the second light source are controllable independently of each other; and a controller operatively coupled to the display and the backlight unit, wherein the controller is configured to dynamically increase output image contrast while adjusting the light level of the second light source for at least one of dim images or bright images while the light level of the first light source is relatively constant.

Aspects of the present invention are directed to a backlighting approach based on a backlight unit (BLU) with independent light sources in which at least one is modulated using an image contrast enhancement technique. Such a BLU can be used to reduce BLU cost and to increase energy efficiency of the BLU and to increase the quality of the image of images produced using the BLU.

The present invention may be used with various types of passive displays and systems. An LCD is an example of a passive display. A passive display modulates light transmitted therethrough and/or reflected thereby. A digital micromirror device (DMD) is another example of a passive display. A ferroelectric display is another type of passive display. There may be other types of passive displays. A passive display typically does not produce its own light but rather modulates light that is directed to, e.g., is incident on, the display to produce an image output.

One aspect of the invention relates to a display system including: a display for producing an output image representative of an input signal that has contrast information and brightness information derivable from the input signal; a backlight unit including a backlight assembly configured to secure a first light source and a second light source, wherein the first light source and the second light source are independent of each other; and a controller operatively coupled to the display and the backlight unit, wherein at least one of the first light source and the second light source is modulated to dynamically increase output image contrast.

Another aspect of the invention relates to a backlight unit including: a first light source; a second light source, wherein the first light source and the second light source are independent of each other; and a frame configured to secure the first light source and the second light source, wherein the frame has a quadrilateral shape with a first side and a second side forming a width of the quadrilateral and a third side and a fourth side forming a length of the quadrilateral.

Another aspect of the invention relates to a backlight unit including: a first light source; a second light source, wherein the first light source and the second light source are independent of each other; and an assembly configured to secure the first light source and the second light source, wherein the assembly has a quadrilateral shape with a first side and a second side forming a width of the quadrilateral and a third side and a fourth side forming a length of the quadrilateral.

Another aspect of the invention relates to a method of controlling contrast of a display image of a display apparatus capable of displaying color within a predetermined gray range having a predetermined number of discrete shades of gray, the display apparatus including a first illuminating light source, a second illuminating light source and a computer control, the method including: processing brightness information and color information of the input image signal, wherein if an input image signal uses a first number of discrete shades of gray that is less than the predetermined number of discrete shades of gray of the display apparatus in a range less than the predetermined gray range, the first number of discrete shades of gray is changed to a second number of discrete shades of gray greater than the first number of discrete shades of gray by holding the amount of light emitted by the first illuminating source substantially constant and adjusting the amount of light emitted from the second illuminating source, wherein the adjusting includes: decreasing the amount of light emitted from the second illuminating source if the image corresponding to the input signal is a dim image; and increasing the amount of light emitted from the second illuminating source if the if the image corresponding to the input signal is a bright image.

Another aspect of the invention relates to a display device for displaying an image, including: a display apparatus capable of displaying color within a predetermined gray range having a predetermined number of discrete shades of gray; a first illuminating light source and a second illuminating light source, wherein the first illuminating light source and the second illuminating light source are independent of each other; and a computer control, wherein the computer control is operable to receive an input signal including brightness and color information using a first number of discrete shades of gray that is less than the predetermined number of discrete shades of gray of the display apparatus in a range that is less than the predetermined gray range; change the first number of discrete shades of gray to a second number of discrete shades of gray used to display an image on the display while adjusting an amount of light from the second illuminating light source by increasing an amount of light from the second illuminating light source if the brightness is high and decreasing an amount of light from the second illuminating light source if the brightness is low and maintaining a substantially constant amount of light output from the first illuminating source.

Another aspect of the invention relates to a method of controlling contrast of a display image of a display apparatus including a first illuminating light source, a second illuminating light source and a computer control, the method including: processing brightness information and determining brightness and a range of gray levels used for an input signal; and increasing the range of gray levels for displaying an image corresponding to the input signal and substantially maintaining output of light emitted from the first illuminating light source and adjusting the amount of light emitted by the second illuminating light source if the image corresponding to the input signal is a dim image.

Another aspect of the invention relates to a method of controlling contrast of a display image of a display, wherein the display apparatus is capable of displaying a color image, including: providing light from a first illuminating light source and a second illuminating light source, wherein the second illuminating light source includes at least three independently controllable colors to illuminate a display of the display apparatus to display an image; and wherein the computer control is used for controlling contrast of the display image such that the processing includes processing brightness information and color information and determining brightness and a range of gray levels for each color used for an input signal; and the increasing and adjusting steps, respectively, include independently by color component increasing the range of gray levels for displaying an image corresponding to the input signal, and, in addition, independently by color component decreasing the amount of light emitted by the second illuminating source if the image corresponding to the input signal is a dim image or independently by color component increasing the amount of light emitted by the second illuminating source if the image corresponding to the input signal is a bright image.

Another aspect of the invention relates to a method of controlling contrast of a display image of a display apparatus capable of displaying color within a predetermined range of gray shade levels, the display apparatus including a first illuminating light source, a second illuminating source and a computer control, the method including: processing brightness information of the input image signal to determine a range of gray levels in the input image and determine whether the image corresponding to the input image signal is a bright image that would provide a high intensity low contrast or a dim image that would provide a low intensity low contrast; and controlling contrast by changing the range of gray levels to a second range of gray levels greater than the first mentioned range of gray levels if the image corresponding to the input signal is a dim image or a bright image, and while maintaining light output from the first illuminating source adjusting the amount of light emitted from the second illuminating light source by decreasing the amount of light if the image corresponding to the input signal is a dim image or increasing the amount of light if the image corresponding to the input signal is a bright image.

Another aspect of the invention relates to a display device for displaying an image, including: a display; a first illuminating light source and a second illuminating light source, wherein the first illuminating light source and the second illuminating light source are independent of each other; and a computer control, wherein the computer control receives an input signal including brightness and color information, determines a range of gray levels used for the input signal and increases the range of gray levels for displaying an image on the display corresponding to the input signal, and while maintaining light output from the first illuminating light source and increasing an amount of light from the second illuminating light source if the brightness is high or decreasing an amount of light from the second illuminating light source if the brightness is low.

Aspects of the invention include the above aspects along with increasing only the range of gray levels or only the number of gray levels or the increasing of both range and number of gray levels.

Aspects of the invention include the above aspects along with altering spectral characteristics of at least one of plural substantially independent light sources of a BLU to compensate for changes in color characteristics of one or more of the lights sources and/or of the display, e.g., due to aging or some other phenomenon.

Another aspect relates to detecting spectral characteristics of light from one or more light sources of a BLU and using the detected information to adjust spectral characteristics of light illuminating a passive.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims. Many aspects of the invention can be better understood with reference to the following drawings.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof”

### BRIEF DESCRIPTION OF THE DRAWINGS

FIG. 1 is a schematic illustration of a display system in accordance with aspects of an embodiment of display system with independently controllable backlight elements in a backlight unit.

FIG. 2 is a schematic illustration of a conventional backlight unit.

FIG. 3 is a schematic illustration of another conventional backlight unit.

FIG. 4 is a schematic illustration of one embodiment of a backlight unit.

FIG. 5 is a schematic illustration of another embodiment of a backlight unit.

FIGS. 6-11 are schematic graphical illustrations depicting exemplary operation.

### DETAILED DESCRIPTION OF EMBODIMENTS

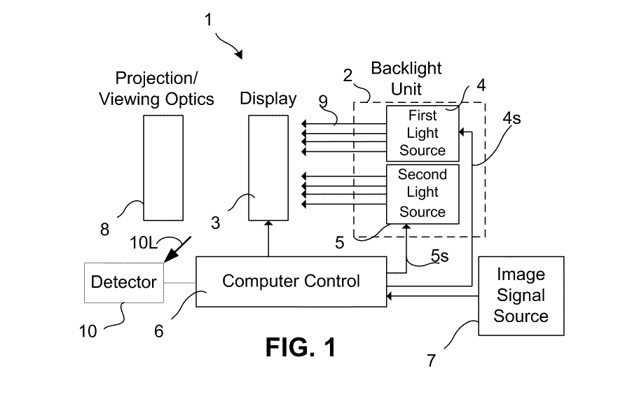

With reference to the drawings, which are not necessarily to scale and wherein like reference numerals refer to like parts in the several figures, and initially to FIG. 1, aspects of the present system relate to a display system 1, method and backlight unit (BLU) 2 for use with a passive display 3. In the description below for brevity the passive display may be referred to as LCD or as display, but it will be appreciated that the invention may apply to other passive displays.

The BLU 2 includes a first light source 4 and a second light source 5 (sometimes respectively referred to as light source units). The first light source and the second light source are independent of each other, e.g., independently controllable such that they may operate independently or substantially independently of each other. The lighting approach based on a BLU 2 including two (or more) independently controllable light sources 4, 5 may be used, as is described in further detail below, to improve the quality of images produced and shown by a passive display and also may reduce BLU cost and may increase efficiency of energy usage.

The display system 1 also includes a controller 6, image signal source or a connection or coupling to such a source, e.g., wired, wireless or otherwise (collectively image signal source 7), and, if needed, viewing optics 8. The controller 6, for example, a computer control, processor, etc., operates the display 3 and the BLU 2 in response to image signals or the like received from the image signal source 7 to provide via the display an image for direct viewing and/or for projection via projection/viewing optics 8. The computer control 6 may be coupled to the first light source 4 by signal control line 4s and may be coupled to the second light source 5 by signal control line 5s. Light 9 from the BLU 2 illuminates (e.g., is incident on) the display 3 to form an image that may be viewed by direct view, viewing via viewing optics and/or projected.

The display (sometimes referred to as a display panel or simply as panel) 3 may be a liquid crystal display (LCD), such as, for example, a twisted nematic liquid crystal cell, a variable birefringence liquid crystal cell, a supertwist liquid crystal cell, or some other type or display able to modulate light. The display 3 may include polarizers, wave plates, such as quarter wave plates or other wave plates, means for compensating for residual birefringence or for problems encountered during off axis viewing, etc. The display 3 may be transmissive, reflective or transflective. Other types of display devices which modulate light as a function of some type of controlled input can be used in place of the display 3. One skilled in the art will readily appreciate that display 3 may be a LCD or another display, such as, flat panel display, digital micromirror device (DMD) display or other display.

In operation of the display system 1 (sometimes referred to as a display device) the controller provides image signals to the LCD 3. The image signals are received by the controller 6 from an image signal source 7. In response to the image signals, the LCD forms an image. The BLU 2 illuminates the LCD 3 so the image can be seen, e.g., shown on or by the display.

In an embodiment the light sources 4 and 5 of the BLU 2 may provide light to illuminate the BLU. With both light sources providing light output, the total amount of light, e.g., brightness of light, illuminating the display is a sum of the light from the light sources. If it is desired to turn down the brightness of the shown image, a user (or the controller 6) may adjust the brightness of one or both of the light sources 4, 5 or may turn off one light source and adjust the other light source, and so on. If the maximum brightness of illuminating light to illuminate the display is desired, or required, then both light sources 4, 5 may be adjusted to produce maximum light output. Neither light source 4, 5 of the BLU 2 individually requires a capability to produce such maximum brightness of illuminating light to illuminate the display; rather each light source 4, 5 may have a relatively lower brightness capability, since the sum of the light output by the two light sources is sufficient to provide such maximum display illuminating brightness. Relatively lower brightness capability light sources tend to be less expensive and/or more energy efficient than relatively higher brightness capability light sources of the same or similar type, and, thus, the use of a BLU as described improves economic efficiency and energy efficiency.

One or both of the light sources 4, 5 also may be adjusted not only to vary the intensity of light produced thereby, but also to adjust spectral characteristics of light output therefrom. For example, as a light source ages, its spectral characteristics may change. A detector 10 may detect the spectral characteristics of light 10L from one or both light sources 4, 5 and/or from the display 3 itself. The controller may make adjustments to the one or both light sources 4, 5 based upon the spectral characteristics detected by the detector 10 to tend to bring the spectral characteristics of the light source(s) into line with desired characteristics or expected tolerances. For example, a light source 4 and/or 5 may be composed of several different color light producing elements, and by changing the manner of energizing the respective light producing elements and/or which is energized, the spectral characteristics of the light source can be altered. In response to an input from the detector 10, the controller 6 may control the energization of the respective light producing elements such that the sum or combination of light produced thereby and, thus, of the light source, has spectral characteristics according to desired characteristics or spectral tolerances.

In an embodiment the controller 6 may adjust the spectral characteristics of both light sources 4, 5, as was described above. Alternatively, if desired, the light controller may adjust spectral characteristics of only one of the two light sources in a manner that brings the sum of light provided by both light sources 4, 5 to desired spectral characteristics. The detector 10 also may detect intensity of light produced by one or both light sources. As light sources age, the intensity of light produced thereby in response to a give energization may change. Thus, the detector may provide input to the controller indicating light intensity, and the controller may effect a change in energization of the light source(s) so that the expected light intensity output is produced to compensate for the effects of aging.

As is described further below, in an embodiment in a passive display system the contrast, contrast ratio and/or the number and/or the range of gray shades or gray levels and also the brightness of the image provided by a passive display system may be independently adjusted.

At least one of the first light source 4 and the second light source 5 may be modulated while the number and/or range of gray levels of an image is increased (sometimes referred to as “expanded”), thereby to dynamically increase contrast of an output image shown on or projected by display 3 to a viewer, for example, in accordance with methods and apparatus referred to as system synchronized brightness control (SSBC), dynamic contrast control and so on. As mentioned above, for brevity such systems collectively will be referred to below as SSBC. The other of the first light source 4 and the second light source 5 may be used to adjust image brightness.

According to an embodiment, the BLU 2 includes at least one of the first and second light sources, e.g., light sources 4 and 5, that can be controlled by the controller 6 with appropriate computer programming or other code in a manner described herein, for example. An algorithm may be used according to SSBC or other image enhancing technique to map grey levels of the original video image into those of an SSBC enhanced image, for example, and as part of that technique one of the light sources may be adjusted, e.g., the light source 5. The brightness of the image shown by the display, sometimes referred to as the display output, is adjustable by variation of the other light source, e.g., the light source 4, of the BLU 2. Adjustment of the light source 4 of the BLU 2 can be thought of as a light level baseline adjustment and is in a sense an additional degree of freedom of the SSBC enhanced image in that overall brightness can be adjusted by adjusting of the light source 4.

As is described in further detail below, using a BLU with independently controllable light sources and controlling those light sources as described herein, both the overall image brightness and the contrast ratio/number of grey shades can be adjusted over a wider range and with a greater degree of independence than was heretofore possible, for example, in a cost effective and energy efficient manner, thus solving problems of cost and energy efficiency encountered in the past with single light source BLU display systems. For example, light sources in prior display systems required to produce high light intensity or brightness levels usually are more expensive and less energy efficient than light sources that produce relatively lower light intensity or brightness levels. In an embodiment the light output amount (brightness or intensity) produced by the combination of light sources 4 and 5 of the BLU 2 may be greater than that produced by a single one of those previously used light sources.

The first and second light sources 4, 5, also referred to as light source units 4, 5, may be adjustable (also referred to as controllable) to provide illumination of variable intensity or brightness and/or spectral characteristics. On the one hand, the illumination light source unit 4 may provide in a sense baseline illumination of the display 3. On the other hand, the light provided by the light source unit 5 may be coordinated by the controller 6 with adjustments made to gray scale characteristics of the image to be displayed, e.g., using an SSBC type of technique to increase contrast and/or contrast ratio characteristics of the image being shown on the display 3. For example, using SSBC techniques the range and/or number of gray levels of an image may be increased relative to the number of gray levels represented in an incoming signal, which represents an image, that is provided to the controller 6 and the intensity of the illumination from the controllable light source unit 5 may be correspondingly adjusted. Thus, the light source units 4, 5 may be referred to for convenience as a substantially constant light source 4 and a controllable (or adjustable) light source 5.

As was mentioned above, one of the light sources, e.g., the substantially constant illumination light source 4, may be adjusted to vary the intensity and/or spectral characteristics of light output therefrom. For example, manual or automatic adjustments, e.g., via the controller 6, may be made in a manner similar to the manner in which a viewer may manually or otherwise adjust the brightness of a monitor, computer display, television, projector or the like or to the manner in which a display may be controlled so as to adjust automatically to ambient light conditions. The controller 6 may adjust the constant illumination light source 4 based on manual input by a user, automatic adjustment based on a detected parameter, e.g., ambient light or some other parameter or both. Exemplary adjustment of the constant illumination light source 4 may be of intensity and/or spectral characteristics. For example, as was mentioned above, the detector may detect spectral characteristics of the light from one or both light sources 4, 5 and, if needed, the controller 6 may make appropriate adjustments to spectral characteristics.

The adjustments of the substantially controllable light source unit 5 may be carried out under constant control and/or variation by the controller 6 in accordance with an SSBC type of technique.

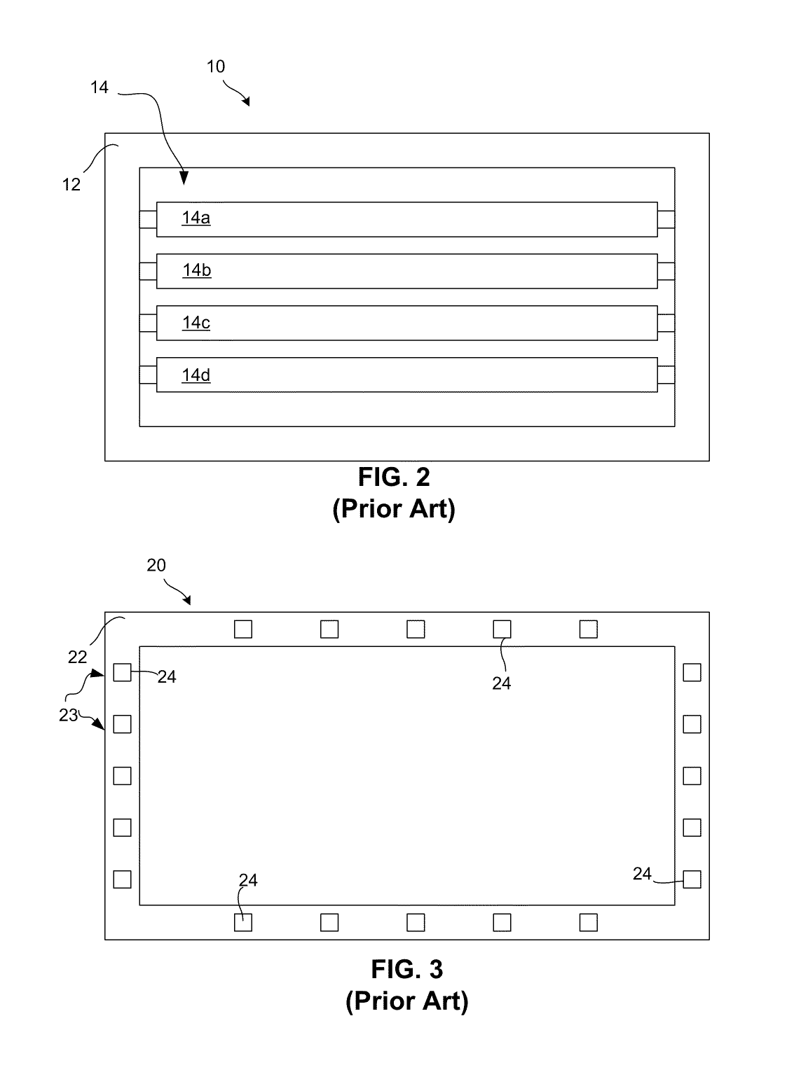

Briefly referring to FIGS. 2 and 3 prior art backlight units (BLU) for illuminating a passive display are illustrated in FIGS. 2 and 3 are illustrated to contrast them relative to BLUs according to the invention. A conventional LCD typically would be illuminated by a conventional BLU that contains a single light source. The single light source may include one or multiple lighting elements that may be controlled as a group to adjust light intensity or brightness of the light produced. Generally, the BLU produces illumination from an area behind and/or at the edges of the display and directs the illumination toward the display. Referring to FIG. 2, the prior art BLU 11 includes a frame 12 that has a single light source 14 composed of one or more lighting elements 14a-14d, which are secured to the frame. The BLU 11 provides area illumination, for example, utilizing fluorescent tubes for the light elements 14a-14d. Common physical forms of the tubes include the use of multiple, straight, parallel-aligned tubes or one or more serpentine shape tubes, for example. Referring to FIG. 3, the prior art BLU 20 includes a frame 22 that has mounted therein a single light source 23 composed of a plurality of light emitting diode (LED) elements 24, e.g., for placement about the edges of the LCD. The LEDs may be either white or colored, e.g., white or a red/green/blue group or triad, or a yellow/magenta/cyan group or triad, for example.

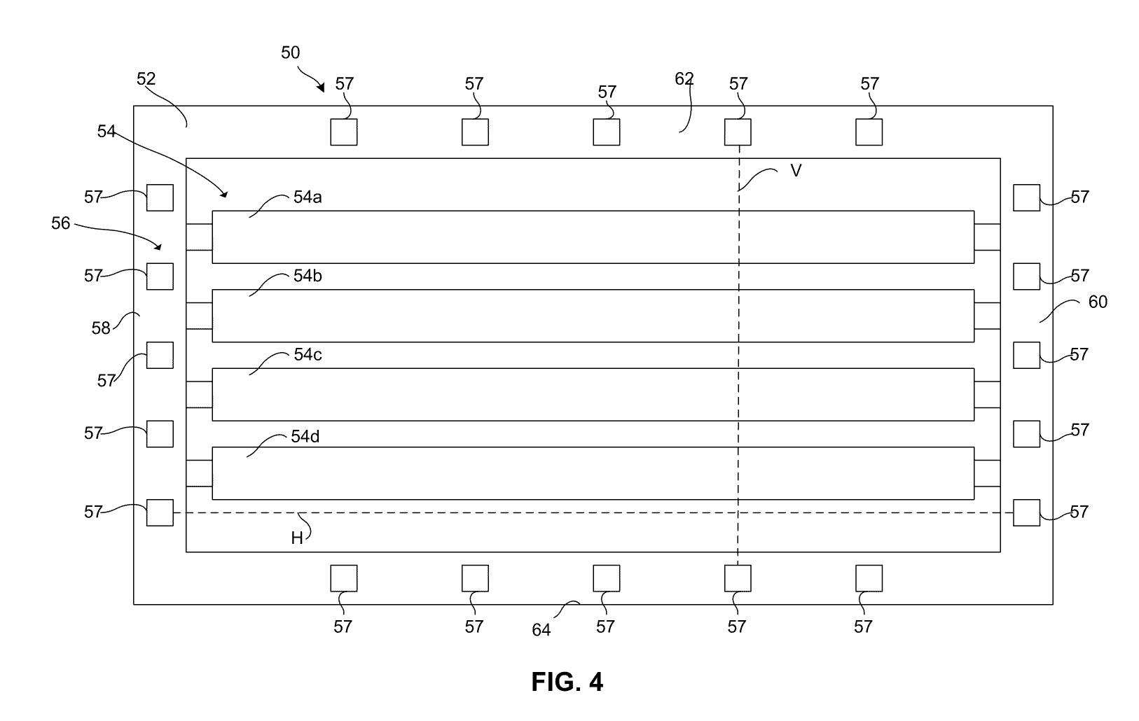

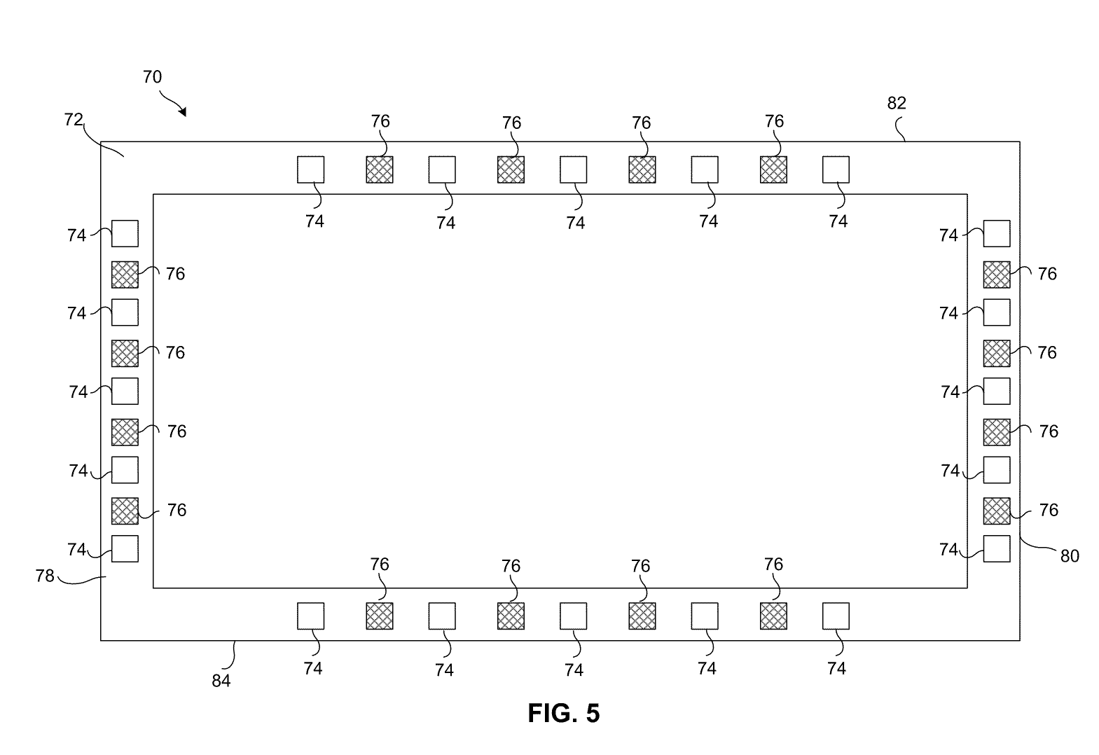

In FIGS. 4 and 5, two examples of embodiments of BLU 2 are shown, respectively as BLUs 50 and 70 in accordance with aspects of the present invention. Each of the BLUs 50, 70 includes first and second light sources, which may be operated independently or substantially independently; and each of the first and second light sources may be composed of one or more light elements. One of the first and second light sources similar to light source unit 4 described above may be operated or controlled to provide, to maintain or to change the brightness (also sometimes referred to as “intensity”), color, color temperature, etc. of the light provided therefrom to illuminate the LCD 3. The light output from such one light source is referred to as a constant light output in that it may be maintained or adjusted based on input provided by a user, may vary according to ambient light conditions, spectral characteristics, or some other parameter and so on, e.g., as was mentioned above. The other of the first and second light sources, e.g., similar to the light source unit 5 described above, may be adjusted based on operation of the system 1 according to SSBC or other displayed image enhancing techniques that are used to enhance an image, e.g., contrast, contrast ratio, or the like, such as what may occur in dim images or in bright images.

The BLUs 50, 70 are described further below. However, it will be appreciated that the BLUs 50, 70 are exemplary embodiments and that other two (or more) part BLUs may be used in accordance with the various aspects of the invention.

Referring to FIG. 4, an exemplary BLU 2 (FIG. 1) in the form of the BLU 50 includes backlight and edge light portions mounted with respect to a frame 52. The frame 52 may be any desirable shape and size to provide suitable illumination for the display 3 (FIG. 1). The size and shape of the BLU 50 and the frame 52 may depend on the size and shape of the display 3 with which the BLU 50 will be used. For example, the shape of the BLU 50 may be square, rectangular or any suitable shape. The sides of the frame may be substantially parallel or otherwise arranged. The frame 52 supports a first light source 54, which may be an area light source, for example, a backlight that illuminates the back area of the display 3. The frame 52 also supports a second light source 56, which is shown, for example, as an edge light source in the form of a plurality of LEDs 57 disposed around the perimeter or periphery of the frame 52, for example, to illuminate the display 3 from its edge.

The BLU embodiment illustrated in FIG. 4 depicts the first light source 54 as an area light source having a plurality of constant light output lighting elements, white and/or color light emitting fluorescent tubes 54 a-d. The various light source elements may be arranged in a predetermined manner spaced apart a predetermined distance, in a random fashion or in some other way. As shown in FIG. 4, the first light source 54 is secured to opposing sides 58, 60 of the frame 52. Alternatively, the first light source 54 may be secured to opposing sides 62, 64 or any other single or combination of sides 58, 60, 62, 64, for example. The first light source 54 may be another type of light source, e.g., a single fluorescent tube, one or more LEDs, one or more laser sources, or other type of light source.

The second light source 56 depicted in FIG. 4 includes a plurality of white and/or color light lighting elements, such as LEDs 57, for example. The second light source 56 may be controlled to control intensity and/or brightness of the light provided therefrom. For example, the LEDs 57 may be controlled to vary brightness of light output. As shown in FIG. 4, the lighting elements 57 (e.g., LEDs) that form the second light source 56 may be arranged in a predetermined manner. For example, the lighting elements 57 arranged on the side 58 may be aligned opposite the respective lighting elements 57 arranged on side 60, as indicated by the dashed line “H”. The lighting elements arranged on the side 62 may be aligned with the lighting elements arranged on the side 64, as indicated by the dashed line “V”. The arrangement of lighting elements illustrated in FIG. 4 is exemplary and the arrangement of the lighting elements may take any desired form. For example, the lighting elements on opposing sides of the frame 52 may be offset from each other, may have a non-uniform distribution, etc. The second light source also may be another type of light source, e.g., one or more fluorescent tubes, laser sources, etc.

The first light source 54 and the second light source 56 may be electrically independent of each other and/or they may be controlled in one or more respects independently or substantially independently of each other. For example, the light sources may be controlled by the controller 6 as to brightness, color, color temperature, or one or more other characteristics and/or various combinations of characteristics.

Referring to FIG. 5, another example of a BLU 2 (FIG. 1) is illustrated as BLU 70 in accordance with aspects of the present invention. The BLU 70 includes a frame 72. The frame 72 may be any desirable shape and size. The shape of the BLU 70 and the frame 72 may depend on the size of the display in which the BLU 70 will be used or other factors, e.g., as was described above for the frame 52. The frame 72 supports a first light source 74 and a second light source 76. As shown in FIG. 5, the first light source 74 and the second light source 76 may be configured along the frame 72 in a predetermined manner. The first light source 74 and the second light source 76 may be electrically independent of each other, as discussed above with reference to first light source 54 and second light source 56, and/or they may be controlled independently or substantially independently of each other.

In one embodiment, the first light source 74 may include a plurality of lighting elements. The plurality of lighting elements may be constant light output, white lighting elements or color lighting elements, such as LEDs, for example. The second light source 76 may be interspersed with the first light source 74 and also may be in the form of a plurality of lighting elements. For example, the modulated lighting elements of the second light source may be white light emitting lighting elements (e.g., white LEDs) or color LEDs, which are arranged along the edges of the frame 70, as shown in FIG. 5.

The lighting elements that form the first light source 74 and the second light source 76 may be arranged in any desired manner. As shown in FIG. 5, the first light source 74 and the second light source 76 may be alternating and aligned along opposing sides of the frame 72. For example, the lighting elements that comprise the first light source 74 and the second light source 76 are illustrated as alternating along each of the sides (78, 80, 82, 84) of the frame 72. In addition, the lighting elements from the first light source 74 on one side (e.g., side 78) may be aligned with the lighting elements from the first light source 74 on an opposing side (e.g., 80). The lighting elements from the second light source 76 may also be aligned along opposing sides. The arrangement of the lighting elements for the first light source 74 and the second light source 76 illustrated in FIG. 5 are exemplary and the arrangement of the lighting elements may take any desired form.

In both embodiments disclosed in FIGS. 4 and 5, the modulated lighting elements that form the second light sources 56, 76 can be replaced by a trio combination (triad) of red/green/blue LEDs, yellow/magenta/cyan LEDs, or other such lighting elements. Such lighting elements can be used to produce white light and/or color light. In an embodiment the lighting elements may be used in a substantially continuous manner without substantial change between a sequence of several or more images (sometimes referred to as frames) provided as signals to produce images via the display 3. In such case one or several lighting elements provide a white light or color light to illuminate the LCD. In another embodiment the lighting elements may operate in the color sequential mode or field sequential mode, e.g., whereby a color is provided to illuminate the display 3 while one frame or part of a frame is shown by the display and another color is provided to illuminate the display 3 while another frame or part of a frame is shown by the display.

As a further embodiment, a laser may be used in accordance with aspects of the present invention, in addition to or instead of the aforementioned lighting elements, e.g., LEDs, fluorescent tubes, etc.

In the embodiments disclosed in FIGS. 4 and 5, the output of the BLU 50, 70, is the sum of the light output by both the first light source (e.g., first light source 54, 74) and the second light source (e.g., 56, 76). A common feature of both embodiments illustrated in FIGS. 4 and 5 is that the BLU 50, 70 configurations are composed of two light sources operated at least substantially independently of each other and of which at least one may be substantially constant and the other may be modulated, as is mentioned elsewhere herein, in accordance with operating principles or functions of SSBC, dynamic contrast control and so on.

For example, the light source unit 74 may provide substantially constant illumination, e.g., constant intensity of light output and/or constant spectral characteristics, e.g., white light or light of other spectral characteristics. The light source unit 76 may be controllable to provide illumination of variable intensity and/or spectral characteristics. On the one hand, the substantially constant illumination light source unit 74 may provide in a sense base line illumination of the display 3. On the other hand, the light provided by the controllable light source unit 76 may be coordinated by the controller 6 with adjustments made to gray scale characteristics of the image to be displayed, e.g., using an SSBC type of technique, to increase contrast and/or contrast ratio characteristics of the image being shown on the display 3. For example, using SSBC techniques the range and/or number of gray levels of an image may be increased relative to the number of gray levels represented in an incoming signal, which represents an image, that is provided to the controller 6 and the intensity of the illumination from the controllable light source unit 76 may be correspondingly adjusted.

In addition to controlling intensity of the BLU 2 (e.g., BLU 50, 70) as a function of brightness or contrast of a scene, the controller 6 also may be responsive to measurement or detection of a parameter, e.g., the ambient environment in which the system 1 is located, or to manual input. For example, the brightness of such ambient environment may be detected by a photodetector or other device, not shown. The photodetector may be placed in a room or elsewhere where the image created by the display 3 is to be viewed; and the brightness of the BLU 2 can be adjusted appropriately. For example, if the room is dark, it usually is desirable to reduce brightness of the light source; and if the room is bright or the apparatus is being used in bright sunlight, the brightness of the light source may be increased. Such base line adjustment may be accomplished through manual or automatic adjustment of the first light source 54, 74, for example.

Referring to FIG. 1 and also to FIGS. 4 and 5, with first light source 4 (e.g., first light source 54, 74) and second light source 5 (e.g., second light source 56, 76) operating independently of each other, the controller 6 may execute an algorithm stored in a memory (not shown) that maps the gray scale levels of the original video image into those of an enhanced image, which has the advantage of an additional degree of freedom compared to a single light source BLU. The display 3 output light level may be adjusted by variation of the second light source 5, as well as by variation of the first light source 4, which may be thought of as a light level base line adjustment. With two independent light sources, both the overall image brightness and the contrast ratio/number of gray shades can be adjusted over a wider range and with a greater degree of independence than in prior display systems. Examples are described further below.

The optics 8 may be one or more lenses separate from and/or included as part of the display 3 for the purpose of providing an output image for viewing or for projection. If for direct viewing, such optics 8 may be one or more lenses which focus an image for close, e.g., as in a head mounted display of the heads up display type, virtual reality type or multimedia type, or far direct viewing, e.g., as in a slide viewer or a television. If for projection, such optics 8 may include projection optics which project an image formed by the display 3 onto a screen for transmissive viewing or reflective viewing. The optics 8 may be unnecessary for viewing a flat television, monitor or other directly viewed display.

The image signal source 7 may be a source of computer graphics signals, NTSC or PAL type television (video) signals, or other signals intended to produce an image on the display 3. Such signals are decoded in conventional manner by the controller 6, which may be an appropriate control, circuit, computer, processor, etc. with associated memory, input/output circuitry and/or components, and so forth, for example, as is the case in many display systems. In response to such decoding or deciphering, the controller 6, which may be, for example, an appropriate control, circuit, computer, processor, etc., operates the display 3 to produce desired images. In one embodiment the controller 6 can operate the display 3 to produce a single image or to produce multiple images in sequence while the display is being illuminated by the BLU 2, including a first light source 4 and a second light source 5. Operation may be monochrome, black and white, or color. If desired, controller 6 can operate the display 3 in field (or frame) sequential manner to produce multiple images in sequence while the display is being illuminated by the BLU 2 providing a respective color of light. In these and other embodiments other exemplary types of operation of the controller 6 include those employed in conventional liquid crystal display televisions of the hand-held or larger type, projectors, computer monitors and other displays. In the mentioned field sequential or frame sequential manner embodiment whereby a particular image or part of an image is formed or sequential frames form respective parts of the image, while one part is formed, the display is illuminated by light of one color, and while another part is formed, the display may be illuminated by light of a different color, and so on.

In a typical input signal to a television or liquid crystal television, there may be information indicating various details of respective images. The information also may indicate brightness of an image, e.g., the light to be transmitted (or reflected) at one or more pixels and/or of the entire image, color, and so on. The controller 6 is operative to compute the brightness information of a particular image or scene and in response to such computation to control the intensity or brightness of one or both of the first light source 4 and the second light source 5 of the BLU 2. While intensity or brightness of the BLU is controlled in this manner, the controller 6 operates the display 3 to modulate light to form an image, e.g., a picture, scene, alphanumeric or other data, etc. In an embodiment, such modulation of light may occur without having to reduce the number of pixels used to transmit light. Therefore, the full number or a relatively large number of pixels can be used to form the image or scene even if the brightness of the scene as controlled by the controlled light source is relatively dark.

The controller 6 may determine, e.g., sense, detect, etc. the number of gray levels of an image as represented by an input image signal received from the input image source 7, recognize if the gray levels are concentrated at relatively dark or relatively bright gray levels, and make adjustments of the gray levels to expand the number and/or range of the gray levels, as is mentioned elsewhere herein. The brightness of light incident on the display also may be adjusted in relation to changes that may be made to the gray levels of the image. For example, if an image is of a relatively dark scene, such as may occur in a moonlit or candle lit environment, the range and/or number of gray levels in the image signal from the image signal source 7 may be concentrated in the relatively dark gray levels; but the controller may expand the range and/or number of gray levels using an appropriate algorithm. This expansion may increase contrast or contrast ratio, on the one hand, but may lead to an increase in brightness of the image that would be shown on the display, on the other hand. To bring the image back to its natural illumination characteristic, e.g., representing the relatively dark environment, the controller 6 may reduce the brightness of the illuminating light source, e.g., light source 5 of the BLU 2. If an image is of a relatively bright scene, such as may occur on a bright sunlit beach, the range and/or number of gray levels in the image signal from the image signal source 7 may be concentrated in the relatively bright gray levels; but the controller may expand the range and/or number of gray levels using an appropriate algorithm to increase contrast or contrast ratio. This expansion may lead to a decrease in brightness of the image that would be shown on the display. To bring the image back to its natural illumination characteristic, e.g., representing the relatively bright environment, the controller 6 may increase the brightness of the illuminating light source.

It will be appreciated that a person having ordinary skill in the art would be able to prepare an appropriate computer program to provide the integral, mathematics and/or other functions, gray levels range and/or number expansion, brightness controls, and/or other controls and to use the results thereof to provide brightness controls for the first light source 4 and the second light source 5.

Examples of commercial systems that use various algorithms and hardware to provide SSBC type control (sometimes referred to as dynamic contrast, dynamic contrast control and so on) are sold by LG Philips under the name digital fine contrast (DFC), by NEC under the name Advanced DVM, by AUO under the name AUO Picture Enhancer (APE), and by Acer under the name Adaptive Contrast Management (ACM). Other systems and methods to provide such control also may exist or may come into existence in the future. In their respective ways these systems may coordinate (i) the expanding the range and/or number of gray levels of an image to be shown on a display and (ii) the brightness of the light that illuminates the display. In the description herein these and other systems that expand the range and/or number of gray levels and control the light source brightness are referred to collectively as SSBC system.

Electromagnetic radiation output, e.g., visible light 9 and/or some other wavelength(s) of such electromagnetic radiation, hereinafter referred to below as “light,” from the BLU 2 is provided the display 3, which may appropriately modulate the light under control by the controller 6 to provide images for viewing and/or projection as the output from the system 1.

The system 1 including the controller 6 is operative to control or to adjust the brightness of a scene without degrading the contrast ratio of the scene or image. Thus, the contrast or contrast ratio can be maintained the same and/or improved while brightness of a scene or image is adjusted. For example, the same contrast ratio or substantially the same contrast ratio can be maintained and/or improved by the display 3, whether depicting a scene of a bright sunlit environment or of the inside of a dark cave. Therefore, the image will have the appearance of illumination under natural illumination conditions, for example.

As shown in FIG. 1, the controller 6 is operatively coupled to the display 3 and the backlight unit (BLU) 2, wherein at least one of the first light source 4 and the second light source 5 is modulated to dynamically increase output image contrast, as discussed below. The controller 6 is operative to provide modulation of the BLU 2 to improve the quality of the image displayed to the viewer.

The following description is presented with respect to a display system 1 that includes SSBC features and functions together with a two light source BLU 2, e.g., having two light sources 4 and 5 that are independently controlled. The first light source 4 may be adjusted to set a base line brightness or illumination for the display 3. The first light source may be adjusted based on user preferences, viewing environment, etc. Generally, the first light source 4 is not controlled based on the image signal received from image signal source 7 and, therefore, may be referred to as a constant or a constant output light source. The second light source 5 is operative to modulate light in accordance with SSBC operation or technique to increase contrast and/or contrast ratio characteristics of image being shown on the display 3 as the number of gray levels and/or range of gray levels may be increased or expanded.

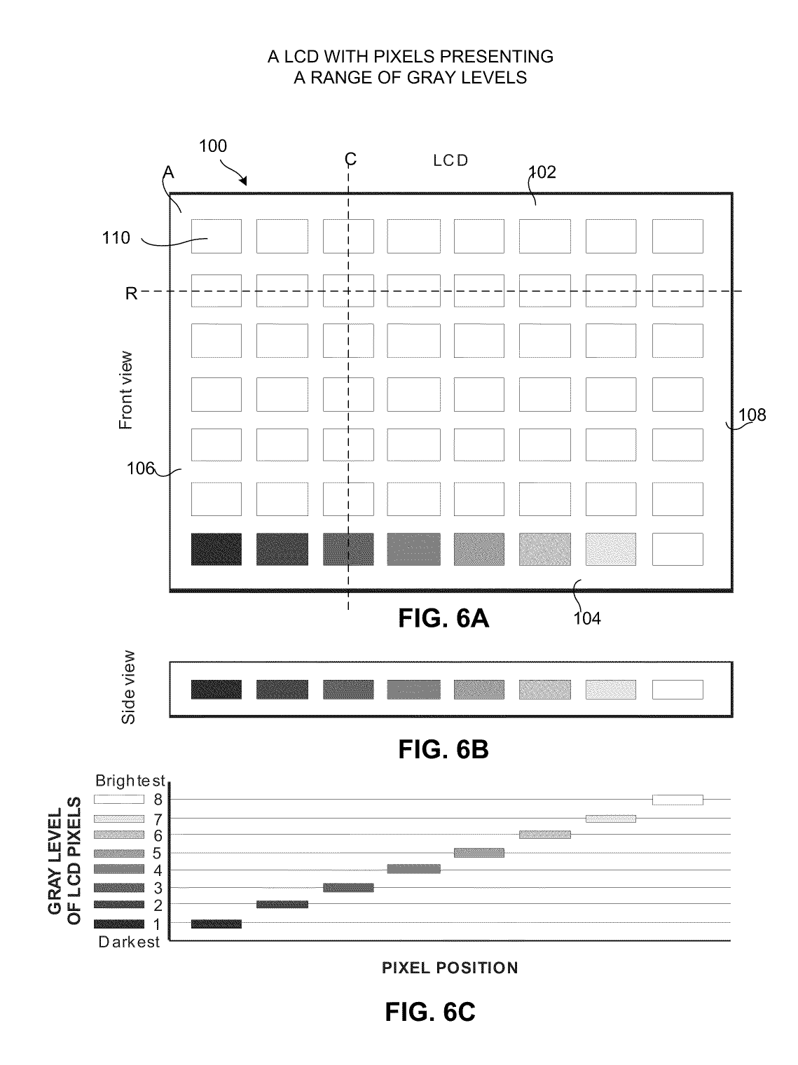

The description below with respect to FIGS. 6-11 illustrates operation of embodiments of a passive display system that includes a passive display, a controller and a BLU.

FIGS. 6A-6C provide an exemplary illustration of a display 100 (e.g., AMLCD) in a display system (e.g., display system 1). FIG. 6A schematically illustrates a front view of the display 100.

The display 100 includes a top edge 102, bottom edge 104 and opposing side edges 106, 108. The area (A) bound by edges (102, 104, 106, 108) includes a plurality of pixels 110. The pixels 110 may be arranged in respective rows (R) and columns (C). Although the exemplary display 100 is illustrated with only seven rows and eight columns of pixels to facilitate showing and describing the invention, it will be appreciated that a typical display may have more or fewer rows and columns of pixels.

FIG. 6B schematically illustrates a bottom edge 104 of the display 100. The exemplary gradation of gray scale or gray levels of FIG. 6A also is shown in FIG. 6B.

7CIn FIG. 6A an exemplary gradation of gray scale levels from black (darkest) to white (brightest) is shown for the respective eight pixels along the bottom row of pixels. A similar gradation is shown in FIG. 6B, which depicts a bottom edge view of such bottom row of pixels from FIG. 6A. FIG. 6C is an exemplary schematic graphical representation of a gradation of gray levels 1 (darkest) through 8 (brightest) corresponding to the eight gray levels in FIGS. 6A and 6B.

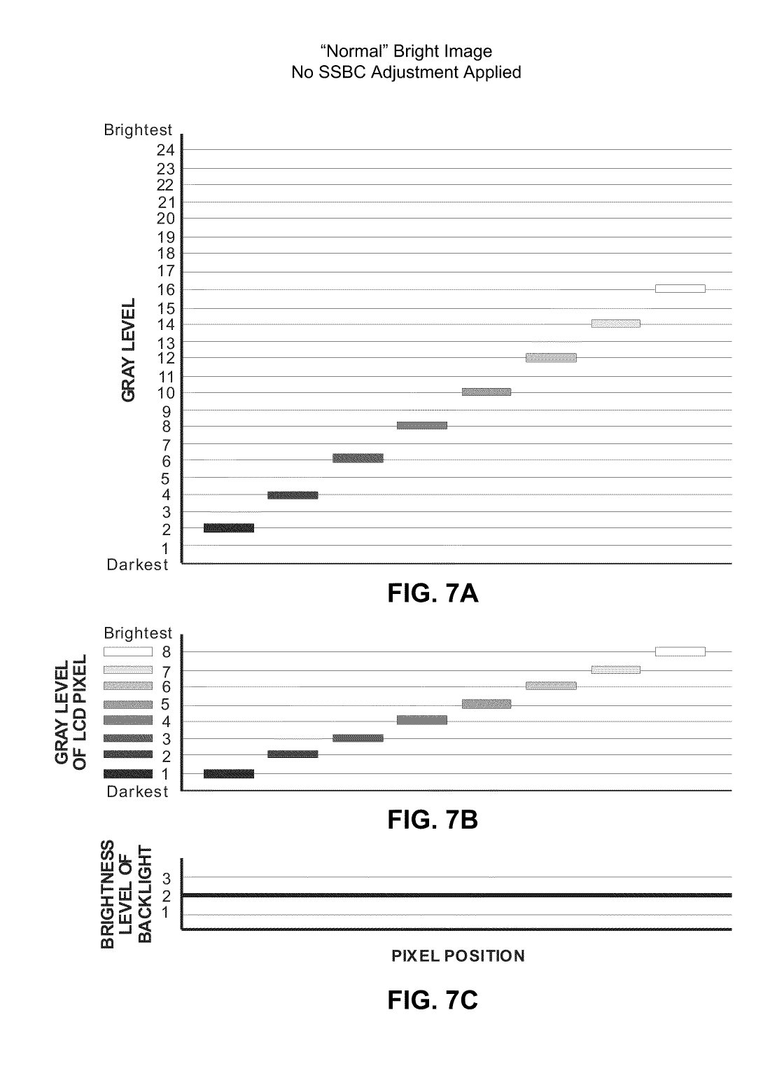

Although the BLU 2 (FIG. 1) is not shown in FIG. 6A-6C, the range of light that can be output by the BLU may be defined to extend over a range; an exemplary range is from a low of “level 1” to a high of “level 3” as is represented schematically in FIG. 7C. In FIG. 6A, it is assumed that the backlight output of the second light source (e.g., 5, 56, 76) is at a given level, for example, at “level 2” as shown in FIG. 7C.

The pixels 110 illustrated adjacent the bottom edge 104 present a range of gray levels. FIG. 6B is a representative side view of the display 100 featuring the pixels 110 that present the range of gray levels. FIG. 6C is a graphical representation, on a pixel by pixel basis, of the gray levels produced by the display 100. In this example, only a few (e.g., eight (8)) gray levels are illustrated and these vary uniformly from full dark shown at the left in the illustration to full bright at the right in the illustration, for example. By definition, the darkest gray level may be labeled as “level 1” and the brightest gray level as “level 8”, as illustrated in FIG. 6C. The intermediate gray levels are numbered between 1 and 8. Note that a real display 100 would actually have the capability to display a much larger number of gray levels, for example, with 256 or more levels. Furthermore, the pixels may be arranged in triads and associated with red/green/blue filters, for example.

With respect to FIGS. 6A-6C, it should be noted that the pixels utilize the full range (e.g., all 8 gray levels) that the display 100 is capable of producing, for example. Such an image will be referred to herein as one of “normal” brightness. The contrast ratio of the image is given by the following equation:

$${CR}_{INTRA} = \frac{( Brightness\_of \_the \_brightest \_pixel )}{( Brightness\_of \_the \_darkest \_pixel )} \qquad ( 1 )$$

As set forth above, the contrast ratio has been defined and is determined by the ratio of the brightness of pixels within a single image (e.g., within a single video frame). In this sense, a more complete name for this quantity would be the intra image or intra frame contrast ratio (CR_{INTRA}).

The illustration in FIGS. 7A-7C will be used to analyze the image produced by such a display system and, therefore, the image seen by the viewer. Starting with FIG. 7C, the graph indicates that the BLU (e.g., second light source 5, 56, 76) is at light output “level 2” and uniform across all of the pixels of the display 100. FIG. 7B graphically illustrates the gray levels of the display 100. In this example, the image is also of “normal” brightness and utilizes all 8 gray levels that can be produced by the display 100. FIG. 7A illustrates the product of the two figures (e.g. FIGS. 7B and 7C) and represents the brightness profile of the image as seen by the viewer.

Notable features regarding the “normal” brightness image presented in FIGS. 7A-7C include: eight (8) different gray levels are used in this “normal” brightness image; there is no contouring in any portion of the image. The maximum brightness (brightest shade of gray) pixel is at level 16 in FIG. 7A, and the minimum brightness (darkest shade of gray) pixel is at level 2 in FIG. 7A. The contrast ratio of this “normal” brightness image in FIG. 7A is given by:

$${CR}_{INTRA} = \frac{( Brightness\_of \_pixel \_level \_ 16 )}{( Brightness\_of \_pixel \_level \_ 2 )} = 8 \qquad ( 2 )$$

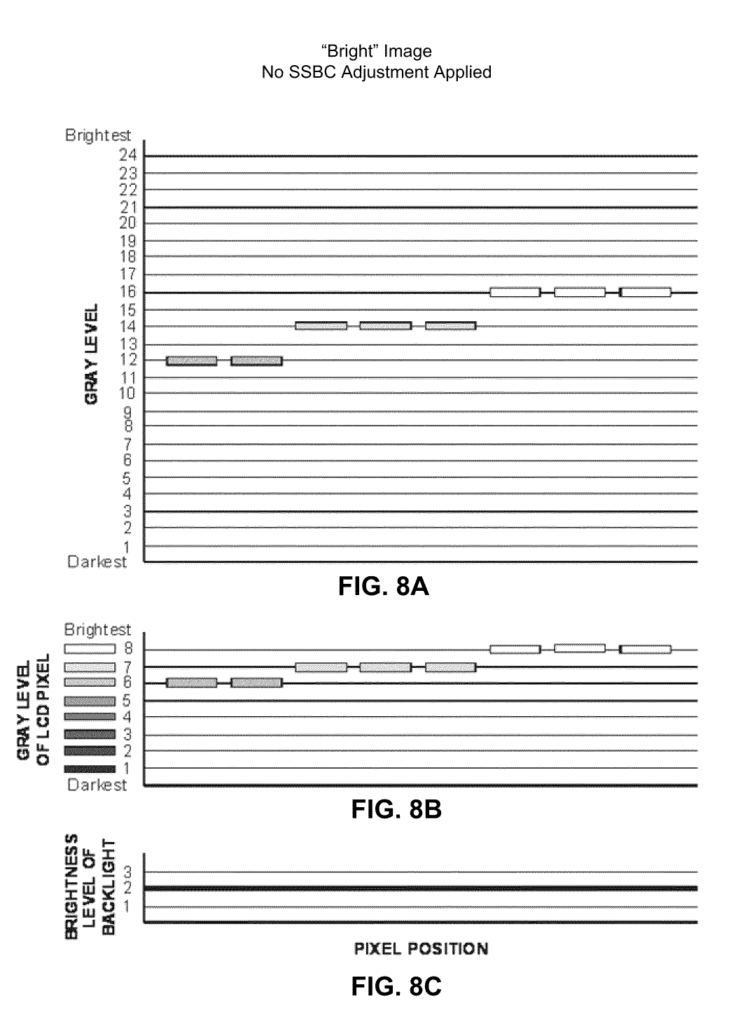

Next, consider two different possibilities for the brightness of the image. The first case is for the “bright” image illustrated in FIGS. 8A-8C. Referring to FIG. 8C, the light output of the backlight is “level 2”. In order to create a “bright” image as is represented by an input image signal from an input image source, such as that shown at 7 in FIG. 1, the display 100 utilizes only the brightest gray levels 6, 7 and 8, which is illustrated in FIG. 8B. FIG. 8A illustrates the product of FIGS. 8B and 8C and represents the brightness profile of the image as seen by the viewer.

The following are notable features regarding the “bright” image presented in FIGS. 8A-8C: three (3) different gray levels are used in this “bright” image, which is manifested as contouring in the bright areas of the image; and the contrast ratio of this “bright” image is given by:

$${CR}_{INTRA} = \frac{( Brightness\_of \_pixel \_level \_ 16 )}{( Brightness\_of \_pixel \_level \_ 12 )} = 1.33 \qquad ( 3 )$$

Compared to the “normal” brightness image, e.g., as is represented in FIGS. 7A-7C, the “bright” image has: (1) less gray levels, which means that it is not possible to render subtle gradations of light in the bright areas; (2) contouring is apparent in the bright areas of the image; and (3) the “bright” image has a lower contrast ratio than the “normal” brightness image.

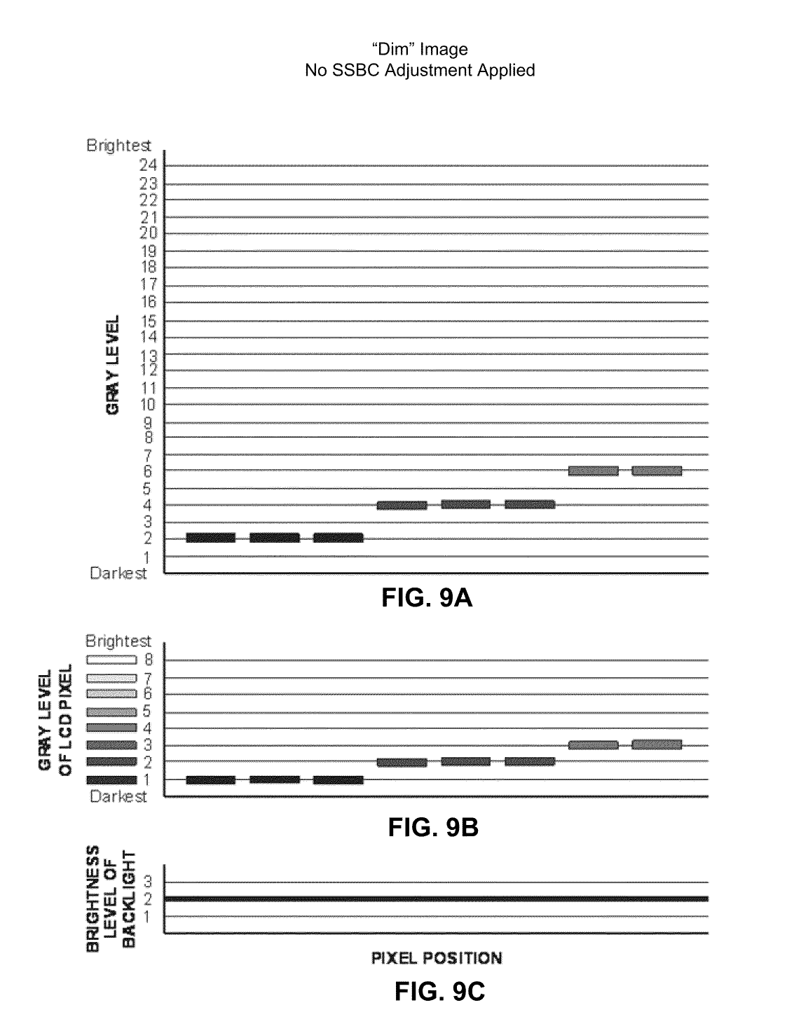

Another exemplary case is for a “dim” image, which is illustrated in FIGS. 9A-9C. Referring to FIG. 9C, the light output of the backlight is “level 2”. In order to create the “dim” image, the display 100 utilizes only the darkest gray levels 1, 2 and 3, which is illustrated in FIG. 9B. FIG. 9A, illustrates the product of FIGS. 9B and 9C, which represents the brightness profile of the image, as seen by the viewer.

The following are notable features regarding the “dim” image in FIGS. 9A-9C: three (3) different gray levels are used in this “dim” image, which is manifested as contouring in the dim areas of the image; and the contrast ratio of this “dim” image is given by:

$${CR}_{INTRA} = \frac{( Brightness\_of \_pixel \_level \_ 6 )}{( Brightness\_of \_pixel \_level \_ 2 )} = 3 \qquad ( 4 )$$

Compared to the “normal” brightness image the “dim” image has: (1) less gray levels, which means that it is not possible to render subtle gradations of light in the dim areas; (2) contouring is apparent in the dim areas of the image; and (3) the “dim” image has a lower contrast ratio than the “normal” brightness image, e.g., as is represented in FIGS. 7A-7C.

It should be noted with respect to FIGS. 8A-8C (bright image) and 9A-9C (dim image), the contrast of the image is reduced. A reduction in contrast generally means that subtleties in the image are not visualized and contouring is apparent.

SSBC addresses one or more of these problems. SSBC apparatus and method in a passive display system adjusts the brightness of the backlight in conjunction with adjustment of the gray levels to improve image quality by increasing contrast and/or contrast ratio.

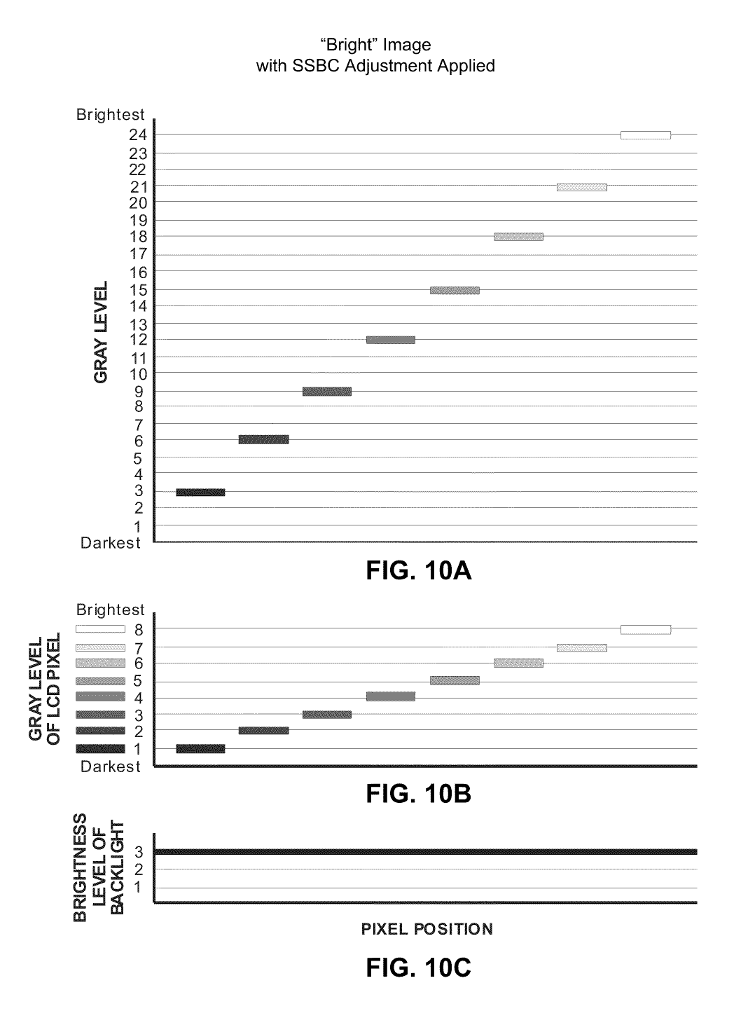

SSBC will now be explained through the use of the following two examples. Re-consider the case of the “bright” image as was previously illustrated in FIGS. 8A-8C. FIGS. 10A-10C illustrate the case of the “bright” image when a SSBC adjustment is applied. With SSBC applied, the light output of the backlight has been increased to brightness “level 3”, as illustrated in FIG. 10C. At the same time, as illustrated in FIG. 10B, the range of gray levels used in the image has been expanded, from three (3) levels to the full eight (8) level capability of the display 100, for example.

Notable features of the SSBC adjusted “bright” image in FIGS. 10A-10C are that eight (8) different gray levels are used in this SSBC adjusted “bright” image and the contrast ratio of this SSBC adjusted “bright” image is given by:

$${CR}_{INTRA} = \frac{( Brightness\_of \_pixel \_level \_ 24 )}{( Brightness\_of \_pixel \_level \_ 3 )} = 8 \qquad ( 5 )$$

Compared to the “normal” brightness image, the SSBC adjusted “bright” image has a similar number of gray levels, which means that there has been no reduction in the ability of the display system to render subtle gradations of light in bright areas. Thus, contouring is not apparent in the bright areas. In addition, there is an equal contrast ratio. In other words, the quality of the “bright” image with the SSBC adjustment is much improved compared to the “bright” image without the SSBC adjustment.

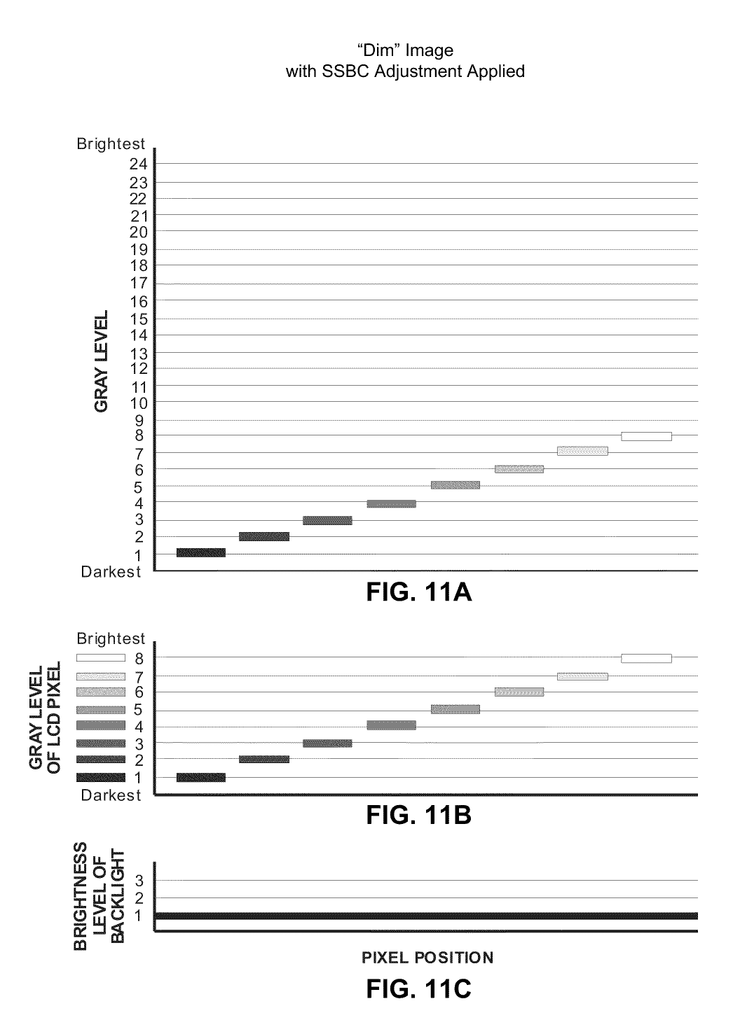

FIGS. 9A-9C illustrate the “dim” image case with no SSBC adjustment. FIGS. 11A-11C illustrate the case of the “dim” image when a SSBC adjustment is applied. Referring to FIG. 11C, the light output of the backlight has been decreased to brightness “level 1”. Referring to FIG. 11B, at the same time, the range of gray levels used in the image have been expanded, back to the full eight (8) level capability of the display 100.

Notable features associated with the SSBC adjusted “dim” image in FIGS. 11A-11C are that eight (8) different gray levels are used in this SSBC adjusted “dim” image. The contrast ratio of this SSBC adjusted “dim” image is given by:

$${CR}_{INTRA} = \frac{( Brightness\_of \_pixel \_level \_ 8 )}{( Brightness\_of \_pixel \_level \_ 1 )} = 8 \qquad ( 6 )$$

Compared to the “normal” brightness image, the SSBC adjusted “dim” image has a similar number of gray levels meaning that there has been no reduction in the ability of the display system to render subtle gradations of light in dim areas. In addition, contouring is not apparent in the “dim” areas of the image. The adjusted “dim” image also has a contrast ratio that is equal to the “normal” brightness image. In other words, the quality of the “dim” image with the SSBC adjustment is much improved compared to the “dim” image without the SSBC adjustment. One accomplishment of the SSBC adjustment is to render the intra screen contrast ratio of the “bright” and “dim” images equal to that of the “normal” brightness image. There is, however, another possible definition of contrast ratio, which may be called the inter frame contrast ratio and can be defined as follows:

$${CR}_{INTER} = \frac{( Brightness\_of \_the \_brightest \_pixel \_in \_a \_ '' bright '' \_frame )}{( Brightness\_of \_the \_darkest \_pixel \_in \_a \_ '' dim '' \_frame )} \qquad ( 7 )$$

It has been determined that the human vision system actually perceives the contrast ratio of a video image along the lines defined by inter frame contrast ratio. Therefore, when SSBC is applied, the inter frame contrast ratio is given by:

$$\begin{matrix}{CR}_{INTER} = \frac{( Brightness\_of \_the \_brightest \_pixel \_in \_a \_ '' bright '' \_frame )}{( Brightness\_of \_the \_darkest \_pixel \_in \_a \_ '' dim '' \_frame )} \\ = \frac{24}{1} \\ = 24\end{matrix} \qquad ( 8 )$$

From equation 8, it is determined that the SSBC adjustment also serves to increase the perceived or inter frame contrast ratio of the video image. The brightness of the brightest pixel in a bright frame may be the value 24 as is shown in the upper right of the graph or chart of FIG. 10A; and the brightness of the darkest pixel in a dark frame may be the value 1 as is shown at the lower left of the graph or chart of FIG. 9A.

The above examples were based on a configuration in which the modulated BLU (e.g., second light source (e.g., 5, 56, 76) was a white light source, for example. An alternative to this is that the BLU may be composed of separate red, green and blue light sources. With three separate colored light sources each independently controlled by SSBC, it is possible to actively adjust not only the brightness, contrast ratio and shades of gray but also the colors of the image.

Furthermore, display systems exist in which a BLU having a single light source that includes white or red/green/blue LEDs arranged in an area array behind the display. At this time, the resolution of such a BLU is typically lower than that of the resolution of the pixels in the display. Application of SSBC to such a backlight array allows real time adjustment to the optical qualities of portions of the entire image.

In both embodiments disclosed in FIGS. 4 and 5 the modulated light output (e.g., the second light sources 56, 76) may be in the form of white light emitting LEDs, for example. Alternatively, the modulated light output also can be in the form of a trio (triad) combination of red/green/blue LEDs, for example. Such LEDs can be used to produce white light, another color light or, can operate in the field sequential or color sequential mode. In addition, a laser may also be used in accordance with aspects of the present invention, rather than or in addition to LEDs.

In the embodiments disclosed in FIGS. 4 and 5, the output of the BLU, for example BLU 50, 70 is the sum of the light output by both the first light source (e.g., first light source 54, 74) and the second light source (e.g., 56, 76). The algorithm that maps the gray scale levels of the original video image into those of the SSBC enhanced image now has the advantage of the additional degree of freedom. Thus, in addition to SSBC adjustment, the display output light level also may be adjustable by variation of the constant light output light source (e.g., the first light source 54, 74), which may be thought of as a light level base line adjustment. With this new method, both the overall image brightness and the contrast ratio/number of gray shades can be adjusted over a wider range and with a greater degree of independence.

As stated above, a common feature of both embodiments illustrated in FIGS. 4 and 5 is that the BLU configurations (e.g., BLUs 50, 70) are composed of two independent light sources of which at least one is modulated. There are a variety of benefits of a BLU having two independent light sources, wherein at least one of the independent light sources is modulated. With proper design, it is possible to implement the configurations shown in FIGS. 4 and 5 at less cost than either configuration illustrated in FIGS. 2 and 3. One reason for this is that the lighting elements that emit at a high light level are more expensive than lighting elements that emit at a lower light level. This is true of both LEDs and area backlights.

Furthermore, with proper design, it is possible to implement the configurations shown in FIGS. 4 and 5 so as to have lower energy consumption than either configuration illustrated in FIGS. 2 and 3. One reason for this is that an emitter that produces a high light level is less energy efficient than one that emits at a lower light level. This is true of both LEDs and area backlights.

Additionally, with proper design, the light output produced by the combination of the two independent light sources illustrated in FIGS. 4 and 5 will be greater than that produced by the single light emitter in either configuration shown in FIGS. 2 and 3.

Another benefit is the ability to adjust spectral output of the display. For example, consider the cases illustrated in FIGS. 4 and 5, wherein the second light source 56, 76 comprise lighting elements that have separate red/green/blue LEDs. In such cases, it is possible to individually and independently adjust the output of the red, green of blue LEDs so to adjust the spectral output of the BLU. The adjustment can be made on a variety of bases including user preference, temperature or the aging of the BLU system. For example, in conventional BLU systems that utilize fluorescent tubes or white LEDs, not capability exists to adjust the spectrum (color) of light produced by the backlight. In addition, if the spectral characteristics of the backlight change with temperature or with aging, for example, conventional BLUs have no capability to adjust the output. FIGS. 1 and 4-11 illustrate BLU configurations that lessen the rate at which cost and energy consumption increases as the size of the BLU increases and that implement SSBC, for example, in a way that increases the available display brightness. Furthermore, the disclosed BLU configurations provide a mechanism to adjust the spectral output of the backlight. 35. For example, the controller may control the second light source based on the spectral output of the first light source and/or the controller may control the second light source based on changes in spectral output of the first light source.

It should be noted that it is possible to implement the dual light source backlighting analogous to that discussed above in rear projection display systems. In a first case, two independent white light output light sources may be used and their output combined in a light engine. At least one of the light sources may be modulated. In a second configuration, one light source may be a steady white light output light source and the other may be either a red/green/blue combined or color sequential, modulated light source.

It will be apparent to a person having ordinary skill in the art of computer programming, how to program the display system described herein to operate and carry out logical functions associated with image contrast enhancement using SSBC, for example, using a BLU having a first light and a second light source that are independent of each other. Accordingly, details as to specific programming code have been left out for the sake of brevity. Also, while the functions and may be executed by respective processing devices in accordance with an embodiment, such functionality could also be carried out via dedicated hardware or firmware, or some combination of hardware, firmware and/or software.

Although certain embodiments have been shown and described, it is understood that equivalents and modifications falling within the scope of the appended claims will occur to others who are skilled in the art upon the reading and understanding of this specification.

What is claimed is:

1. A lighting unit for a passive display, comprising
a first light configured to illuminate a passive display,
a second light configured to illuminate the passive display, and
wherein the first light and second light are independently controllable.

2. The lighting unit of claim 1, wherein the sum of the total light capability of the first light and second light is at least approximately the maximum light intended for illuminating the display.

3. The lighting unit of either of claim 1 or 2, wherein at least one light provides minimum light for operating the display to show a directly viewable or projectable image absent any light from the other light.

4. The lighting unit of any of claims 1-3, wherein the lights are cooperatively operable to provide illumination of a display over the full intended operating brightness of the display.

5. The lighting unit of any of claims 1-4, wherein at least one of the lights comprises a plurality of lighting elements.

6. The lighting unit of any of claims 1-5, wherein each of the lights comprises a plurality of lighting elements.

7. The lighting unit of any of claims 1-6, wherein at least one of the lights comprises LEDs.

8. The lighting unit of any of claims 1-7, wherein at least one of the lights comprises at least one fluorescent tube.

9. The lighting unit of any of claims 1-8, wherein at least one of the lights comprises a laser.

10. The lighting unit of any of claims 1-9, wherein at least one of the lights is configured to control the spectral output of light provided thereby.

11. A passive display comprising a light modulator configured to modulate light to show an image, and the lighting unit of any of claims 1-10 configured to illuminate the light modulator.

12. The passive display of claim 11, wherein at least one of the lights provides a color output and is configured to create natural illumination or enhanced color of the image to adjust for changes due to aging or the like.

13. The passive display of either of claim 11 or 12, further comprising a detector configured to measure spectral output of at least one of the lights.

14. The passive display of any of claims 11-13, further comprising a control configured to control operation of at least one of the lights over a range of brightness levels.

15. The passive display of any of claims 11-14, wherein the control is configured to increase the range or number of gray levels shown by the light modulator for dim images or bright images and to coordinate controlling of at least one of the lights therewith.

16. The passive display of any of claims 11-15, wherein the sum of maximum brightness light of the first light and second light is at least substantially the same as the maximum brightness light of a single relatively higher powered light.

17. The passive display of any of claims 11-16, wherein the light modulator is a liquid crystal device.

18. The passive display of any of claims 11-16, wherein the light modulator comprises a plurality of mirrors.

19. The passive display of any of claim 11-16 or 18, wherein the light modulator is a digital micromirror device.

20. A display device for displaying an image, the display device comprising:
a passive display panel;
a backlight unit configured to illuminate the display panel; and
at least one control operatively coupled to the passive display panel and the backlight unit;
wherein the backlight unit comprises a first independently controllable light source and a second independently controllable light source, wherein the first light source is controlled to provide substantially constant light output and the second light source is controlled to provide modulated light output.

21. The display device of claim 20, wherein said passive display panel comprises a LCD.

22. The display device of claim 20, wherein said passive display panel comprises a multiple mirrors.

23. The display device of either of claim 20 or 22, wherein said passive display panel comprises a digital micromirror device.

24. The display device of claim 20, wherein said passive display panel comprises a ferroelectric display.

25. A display system comprising:
a display for producing an output image representative of an image signal;
a backlight unit configured to illuminate the display and including a first light source and a second light source, wherein the first light source and the second light source are controllable independently of each other; and
a controller operatively coupled to the display and the backlight unit, wherein the controller is configured to dynamically increase output image contrast while adjusting the light level of the second light source for at least one of dim images or bright images while the light level of the first light source is relatively constant.

26. The display system of claim 25, wherein the first light source is controlled by the controller to output a substantially constant illumination.

27. The display system of either of claim 25 or 26, wherein the first light source is adjustable to determine a baseline light level illuminating the display.

28. The display system of any of claims 25-27, wherein the controller is configured to increase the number and/or range of gray levels of a displayed image for at least one of relatively dim images or relatively bright images and to control the brightness of the second light source.

29. The display system of any of claims 25-28, wherein the controller is configured to control the first light source.

30. The display system of any of claims 25-29, wherein spectral output of the first light source is adjustable, and wherein the first light source illuminates the display to cause the display to show images under natural illumination as the number and/or range of gray levels is increased.

31. A display device for displaying an image, the display device comprising:
a passive display panel;
a backlight unit configured to illuminate the display panel; and
at least one control operatively coupled to the passive display panel and the backlight unit;
wherein the backlight unit comprises a first independently controllable light source and a second independently controllable light source, wherein the first light source is controlled to provide substantially constant light output and the second light source is controlled to provide modulated light output.

32. The display device of claim 31, wherein the first light source comprises at least one white fluorescent lamp.

33. The display device of claim 32, wherein the first light source comprises a plurality of white LEDs.

34. The display device of claim 32, wherein the at least a portion of the first light source is disposed behind a central portion of the passive display panel.

35. The display device of any of claims 31-34, wherein the second light source comprises a plurality of white light emitting diodes (LEDs).

36. The display device of claim 35, wherein at least some of the white LEDs are disposed adjacent edges of the passive display panel.

37. The display device of any of claims 31-36, wherein the second light source comprises a plurality of colored light emitting diodes (LEDs).

38. The display device of any of claims 31-37, wherein the second light source comprises a plurality of red, blue and green LEDs.

39. The display device of any of claims 31-38, wherein control of the second light source is dependent on spectral output of the first light source.

40. The display device of any of claims 31-39, wherein control of the second light source is dependent on changes in spectral output of the first light source.

41. The display device of any of claims 31-40, wherein the second light source is modulated according to substantially maintain at least one of a contrast ratio and a brightness level of an output image displayed on the passive display panel.

42. The display device of any of claims 31-41, wherein the first light source is controlled to provide substantially constant light output at a bright level, a normal level or a dim level.

43. The display system or device of any of claims 1-42, wherein the second light source is controlled by the controller to automatically modulate to dynamically increase output image contrast.

44. The display system or device of any of claims 1-43, wherein the first light source includes a plurality of area light sources arranged in a predetermined manner on the backlight assembly.

45. The display system or device of any of claims 1-44, wherein the plurality of area light sources are spaced apart a predetermined distance.

46. The display system or device of any of claims 1-45, wherein the plurality of area light sources are fluorescent tubes.

47. The display system or device of any of claims 1-46, wherein the plurality of area light sources extend from a first side of the backlight assembly to a second side of the backlight assembly, wherein the first side and the second side are substantially parallel to each other.

48. The display system or device of any of claims 1-47, wherein the backlight assembly has a quadrilateral form having a first member, a second member, a third member and a fourth member, wherein the first member and the second member have a common first length and the third member and the fourth member have a common second length and the first member and the second member are substantially parallel and connected together by the third member and the fourth member.

49. The display system or device of any of claims 1-48, wherein the second light source includes a plurality of second electromagnetic radiation emitting elements that are disposed along a periphery of the backlight assembly, wherein at least one of plurality of the plurality of second electromagnetic radiation emitting elements is secured to each of the first member, the second member, the third member or the fourth member of the backlight assembly.

50. The display system or device of any of claims 1-49, wherein the plurality of second electromagnetic radiation emitting elements are light emitting diodes.

51. The display system or device of any of claims 1-50, wherein each of the second electromagnetic radiation emitting elements include a combination of at least three light emitting diodes capable of generating a plurality of colors.

52. The display system or device of any of claims 1-51, wherein the plurality of second electromagnetic radiation emitting elements are lasers.

53. A backlight unit comprising:
a first light source;
a second light source, wherein the first light source and the second light source are controllable independently of each other; and
a frame configured to secure the first light source and the second light source, wherein the frame has a quadrilateral shape with a first side and a second side forming a width of the quadrilateral and a third side and a fourth side forming a length of the quadrilateral.

54. The backlight unit of claim 53, wherein the first side and the second side are coplanar.

55. The backlight unit of claim 54, wherein the third side and the fourth side are coplanar.

56. The backlight unit of claim 53, wherein the quadrilateral shape is at least one from a group consisting of a square and a rectangle.

57. The backlight unit of claim 53, wherein the first light source includes a plurality of first electromagnetic radiation emitting elements arranged on the frame.

58. The backlight unit of claim 57, wherein at least one of the plurality of first electromagnetic radiation emitting elements are secured on each of the first side, the second side, the third side and the fourth side of the frame.

59. The backlight unit of claim 57, wherein the second light source includes a plurality of second electromagnetic radiation emitting elements arranged on the frame.

60. The backlight unit of claim 59, wherein the plurality of first electromagnetic radiation emitting elements are at least one selected from the group of fluorescent tubes and light emitting diodes.

61. The backlight unit of claim 60, wherein the plurality of second electromagnetic radiation emitting elements are light emitting diodes.

62. The backlight unit of claim 60, wherein the plurality of first light sources and the plurality of second light sources are arranged in a predetermined pattern on each of the first side and the second side.

63. The backlight unit of claim 60, wherein the plurality of first light sources and the plurality of second light sources are arranged in a predetermined pattern on each of the third side and the fourth side.

64. The backlight unit of claim 53, the plurality of first light sources are fluorescent sources of electromagnetic radiation that are secured to first side and second side of assembly or the third side and fourth side of the assembly.

65. The backlight unit of claim 51 further including a controller coupled to the first light source and the second light source, wherein the controller is configured to control the first light source to output electromagnetic radiation at a substantially constant intensity.

66. The backlight unit of claim 65 further including the controller configured to control the second light source in order to substantially maintain at least one of a contrast ratio and a brightness level of the output image.

67. A display device for displaying an image, the display device comprising:
a passive display panel;
a backlight unit; and
at least one control operatively coupled to the passive display panel and the backlight unit;
wherein the backlight unit comprises a first independently controllable light source and a second independently controllable light source, wherein the first light source is controlled to provide substantially constant light output and the second light source is controlled to provide modulated light output.

68. The display device of claim 67, wherein the first light source comprises at least one white fluorescent lamp.

69. The display device of claim 67, wherein the first light source comprises a plurality of white LEDs.

70. The display device of claim 68, wherein the at least a portion of the first light source is disposed behind a central portion of the passive display panel.

71. The display device of any of claims 6-70, wherein the second light source comprises a plurality of white light emitting diodes (LEDs).

72. The display device of claim 71, wherein at least some of the white LEDs are disposed adjacent edges of the passive display panel.

73. The display device of any of claims 67-72, wherein the second light source comprises a plurality of colored light emitting diodes (LEDs).

74. The display device of any of claims 67-73, wherein the second light source comprises a plurality of red, blue and green LEDs.

75. The display device of any of claims 67-74, wherein control of the second light source is dependent on spectral output of the first light source.

76. The display device of any of claims 67-75, wherein control of the second light source is dependent on changes in spectral output of the first light source.

77. The display device of any of claims 67-76, wherein the second light source is modulated according to substantially maintain at least one of a contrast ratio and a brightness level of an output image displayed on the passive display panel.

78. The display device of any of claims 67-77, wherein the first light source is controlled to provide substantially constant light output at a bright level, a normal level or a dim level.

79. A method of controlling contrast of a display image on a display apparatus capable of displaying color within a predetermined gray range having a predetermined number of discrete shades of gray, the display apparatus including a first light source, a second light source and a computer control, the method comprising:
processing brightness information and color information of the input image signal,
wherein if an input image signal uses a first number of discrete shades of gray that is less than the predetermined number of discrete shades of gray of the display apparatus in a range less than the predetermined gray range, the first number of discrete shades of gray is changed to a second number of discrete shades of gray greater than the first number of discrete shades of gray by holding the amount of light emitted by the first illuminating source substantially constant and adjusting the amount of light emitted from the second illuminating source, wherein the adjusting comprises:
decreasing the amount of light emitted from the second illuminating source if the image corresponding to the input signal is a dim image; and increasing the amount of light emitted from the second illuminating source if the if the image corresponding to the input signal is a bright image.

80. The method of claim 79 further comprising providing light from the second illuminating light source having at least three colors to illuminate the display apparatus to display the image.

81. The method of claim 79 further comprising providing light from the second illuminating light source having at least three independently controllable colors to illuminate the display apparatus to display the image; and
wherein the processing brightness information and color information and determining shades of gray is carried out for each color used for the input image signal; and the changing while adjusting comprising independently by color increasing the number of shades of gray used to display an image corresponding to the input image signal while independently by color decreasing the amount of light emitted by the second illuminating source if the image corresponding to the input image signal is a relatively dim image and independently by color increasing the amount of light emitted by the second illuminating source if the image corresponding to the input image signal is a relatively bright image.

82. The method of claim 81, further comprising displaying the image on the display apparatus.

83. A display device for displaying an image, comprising:
a display apparatus capable of displaying color within a predetermined gray range having a predetermined number of discrete shades of gray;
a first illuminating light source and a second illuminating light source, wherein the first illuminating light source and the second illuminating light source are independent of each other; and
a computer control, wherein the computer control is operable to receive an input signal including brightness and color information using a first number of discrete shades of gray that is less than the predetermined number of discrete shades of gray of the display apparatus in a range that is less than the predetermined gray range; change the first number of discrete shades of gray to a second number of discrete shades of gray used to display an image on the display while adjusting an amount of light from the second illuminating light source by increasing an amount of light from the second illuminating light source if the brightness is high and decreasing an amount of light from the second illuminating light source if the brightness is low and maintaining a substantially constant amount of light output from the first illuminating source.

84. The display device of claim 83, wherein the second illuminating light source comprises a plurality of light sources of different colors and each color can be independently controlled.

85. The display device of claim 83, wherein the first illuminating light source comprises at least one selected from the group of fluorescent bulbs and light emitting diodes.

86. The display device of claim 83, wherein the first illuminating light source is held substantially constant.

87. The display device of claim 83, wherein the shades of gray for each respective color of the plurality of light sources is determined for the image and the shades of gray for each of the color components is independently increased for the display and decreasing or increasing the relative brightness of each of the component colors in the illuminating light source by holding light emitted from the first illuminating source substantially constant and adjusting the light emitted from the second illuminating source if the relative brightness of the component is dim or bright relative to the other component colors in the input image.

88. A method of controlling contrast of a display image of a display apparatus including a first illuminating light source, a second illuminating light source and a computer control, the method comprising:
processing brightness information and determining brightness and a range of gray levels used for an input signal; and
increasing the range of gray levels for displaying an image corresponding to the input signal and substantially maintaining output of light emitted from the first illuminating light source and adjusting the amount of light emitted by the second illuminating light source if the image corresponding to the input signal is a dim image.

89. The method of claim 88, the processing brightness information and determining brightness and a range of gray levels used for an input signal comprises using the computer control.

90. The method of any of claims 88 further comprising increasing the amount of light emitted by the second illuminating light source if the image corresponding to the input signal is a bright image.

91. The method of any of claims 88-90, wherein the display apparatus is capable of displaying color within a predetermined range of gray shade levels, and wherein the processing comprises processing brightness information of the input image signal to determine a range of gray levels in the input image and determine whether the image corresponding to the input image signal is a bright image that would provide a high intensity low contrast or a dim image that would provide a low intensity low contrast; and further comprising:
using the increasing the range of gray levels and the adjusting the amount of light emitted by the second illuminating light source to control contrast by changing the range of gray levels to a second range of gray levels greater than the first mentioned range of gray levels if the image corresponding to the input signal is a dim image or a bright image, and adjusting the amount of light emitted by the second illuminating light source by decreasing the amount of light emitted by the second illuminating light source if the image corresponding to the input signal is a dim image or increasing the amount of light output by the second illuminating light source if the image corresponding to the input signal is a bright image.

92. The method of any of claims 88-90, wherein the display apparatus is capable of displaying color within a predetermined range of gray shade levels, wherein the processing comprises processing brightness information of the input image signal to determine a brightness and a range of gray levels in the input image; and using the increasing the range of gray levels and maintaining light output from the first illuminating light source and adjusting the amount of light output by the second illuminating light source to control contrast by changing the range of gray levels to a second range of gray levels greater than the first mentioned range of gray levels if the image corresponding to the input signal is a dim image, and adjusting the amount of light from the second illuminating light source by decreasing the amount of light emitted by the second illuminating light source if the image corresponding to the input signal is a dim image.

93. The method of any of claims 88-90, wherein the display apparatus is capable of displaying color within a predetermined range of gray levels, wherein the processing comprises processing brightness information of the input image signal to determine the brightness of the input signal and the range of gray levels in the input signal that is less than the predetermined range of gray levels; and the increasing the range of gray levels comprises in response to the
determined brightness and the range of gray levels, changing the range of gray levels in the input signal to a second range of gray levels greater than the first mentioned range of gray levels, and adjusting the amount of light from the light source by increasing the amount of light if the brightness is high or decreasing the amount of light if the brightness is low.

94. The method of controlling contrast of a display image on a display, wherein the display apparatus is capable of displaying a color image, comprising:
providing light from a first illuminating light source and a second illuminating light source, wherein the first illuminating light source is held substantially constant and the second illuminating light source includes at least three independently controllable colors to illuminate a display of the display apparatus to display an image; and
wherein the computer control is used for controlling contrast of the display image such that the processing comprises processing brightness information and color information and determining brightness and a range of gray levels for each color used for an input signal; and
the increasing and adjusting steps, respectively, comprise independently by color component increasing the range of gray levels for displaying an image corresponding to the input signal, and, in addition, independently by color component decreasing the amount of light emitted by the second illuminating source if the image corresponding to the input signal is a dim image or independently by color component increasing the amount of light emitted by the second illuminating source if the image corresponding to the input signal is a bright image.

95. A method of controlling contrast of a display image of a display apparatus capable of displaying color within a predetermined range of gray shade levels, the display apparatus including a first illuminating light source, a second illuminating source and a computer control, the method comprising:
processing brightness information of the input image signal to determine a range of gray levels in the input image and determine whether the image corresponding to the input image signal is a bright image that would provide a high intensity low contrast or a dim image that would provide a low intensity low contrast; and
controlling contrast by changing the range of gray levels to a second range of gray levels greater than the first mentioned range of gray levels if the image corresponding to the input signal is a dim image or a bright image, and while maintaining light output from the first illuminating source adjusting the amount of light emitted from the second illuminating light source by decreasing the amount of light if the image corresponding to the input signal is a dim image or increasing the amount of light if the image corresponding to the input signal is a bright image.

96. A display device for displaying an image, comprising:
a display;
a first illuminating light source and a second illuminating light source, wherein the first illuminating light source and the second illuminating light source are independent of each other; and
a computer control, wherein the computer control receives an input signal including brightness and color information, determines a range of gray levels used for the input signal and increases the range of gray levels for displaying an image on the display corresponding to the input signal, and while maintaining light output from the first illuminating light source and increasing an amount of light from the second illuminating light source if the brightness is high or decreasing an amount of light from the second illuminating light source if the brightness is low.

97. The display device of claim 96, wherein the computer control determines brightness represented by the input signal, and wherein the computer control increases and decreases the amount of light from the second illuminating light source by adjusting an amount of light emitted from the second illuminating light source.

98. The display device of either of claims 96-97, wherein the first illuminating light source comprises a plurality of light sources of different colors; and
a computer control, wherein the computer control receives an input signal
including brightness and color information, determines a range of gray levels used for the input signal, and wherein the computer control controls contrast of a displayed image by increasing the range of gray levels for displaying an image on the display corresponding to the input signal, and by increasing an amount of light emitted from the second illuminating light source if the brightness of the input image is high or decreasing an amount of light emitted from the illuminating light source if the brightness of the input image is low.

99. The display device of either of claims 96-97, wherein the second illuminating light
source comprises a plurality of light source components of different colors where each color can be independently controlled.

100. The display device of either of claims 96-97, wherein the range of gray levels for each
component color is determined for the input image and the range of gray levels for each of the color components is independently increased for the display, and in addition, the brightness of each of the component colors emitted by the second illuminating light source is decreased if the brightness of the component is dim or the brightness of each of the component colors in the second illuminating light source is increased if the brightness of the component is bright.

101. The display device of either of claims 96-97, wherein the light source components of the second illuminating light source are light emitting diodes.

102. The display device of any of claims 19-24, wherein the control controls operation of both light sources.
